(19) United States
(12) Patent Application Publication
(10) Pub. No.: US 2007/0111766 A1
(43) Pub. Date: May 17, 2007

(54) Combine harvester having spreader for crop residues

(76) Inventor: Bengt Holmen, Skara (SE)

Correspondence Address: HARNESS, DICKEY & PIERCE, P.L.C., P.O. BOX 8910, RESTON, VA, 20195, US

(21) Appl. No.: 10/562,138

(22) PCT Filed: May 21, 2004
(86) PCT No.: PCT/SE04/00786

§ 371 Date: Dec. 23, 2005

(30) Foreign Application Priority Data
Jun. 24, 2003 (SE) 0301809-0

(51) Int. Cl. A01F 12/30

(52) U.S. Cl. 460/111

(57) ABSTRACT

A spreader, connected to the rear end of a combine harvester, is disclosed for spreading the crop residues existing from a cutter incorporated in the combine harvester behind the spreader across a width that considerably exceeds the width of the combine harvester and the spreader. The spreader includes several spreader wigs pivotally mounted thereon to define the desired spreading width. A wind deflector is mounted on said spreader and upon movement of the spreader in the direction of travel it prevents headwinds and/or lateral winds from affecting the distribution of the crop residues across the spreading width.

### TECHNICAL FIELD

The present invention relates generally to a spreader arranged to move over a ground for spreading crop residues over the ground behind the spreader, across a width that considerably exceeds the width of the spreader. More preferably, the invention concerns a spreader of the above kind, which is connected to the rear end of a combine harvester for spreading the crop residues coming from a cutter incorporated in the combine harvester, said spreader comprising several spreader wings pivotally mounted on said spreader for adjustment of the desired spreading width.

In the preferred embodiment of the present invention described and shown herein the cutter preferably is a straw chopper, preferably a flail chopper. The crop residues preferably consist of ordinary dry straw usually from such crops as wheat, barley, rye and oats. However, the residues could likewise consist of for instance maize, sunflower, etc, comprising fairly large and stiff plant parts.

### BACKGROUND OF THE INVENTION

A spreader of the kind stated in the introduction is previously known from SE 511 138 C2. In a combine harvester of this kind and in all other combine harvesters fitted with a spreader positioned after the cutter it is difficult, under lateral wind conditions, to spread the crop residues in an even and uniform manner across the desired spreading width, which in modern combine harvesters may amount to as much as 9 m or more. Also under calm weather conditions, the spreading width is reduced owing to the headwind or upwind of up to 3 to 4 m/s created by the movement forwards of the combined harvester over the ground.

### OBJECT OF THE INVENTION

The main object of the invention is primarily to alleviate the above-described drawbacks created by the effects of headwind and/or lateral winds and to provide a spreader, which while of simple and reliable construction provides a more even and more uniform spreading of the crop residues on the ground across the spreading width.

### SUMMARY OF THE INVENTION

This main object is achieved in accordance with the invention in that the spreader is provided with a wind deflector, which upon movement of the spreader prevents headwinds and/or lateral winds from affecting the spreading of the crop residues across the spreading width and which is connected to the spreader itself or on the rear end of the combine harvester.

### BRIEF DESCRIPTION OF THE DRAWINGS

The invention will now be described in the following in more detail with reference to the accompanying drawings, wherein:

FIG. 1 is a schematic view as seen obliquely from behind and shows the rear part of a combine harvester having a spreader placed behind or downstream from a cutter and provided with a wind deflector in accordance with a first, presently preferred embodiment of the invention.

FIGS. 2-4 are views as seen from the rear, from above and obliquely from the front, respectively, of the spreader in accordance with FIG. 1 having spreader wings and wind deflector.

FIGS. 5 and 6 show, in a view corresponding to FIG. 1, one of several possible ways of controlling the wind deflector.

FIG. 7 shows in a view from above additional ways of controlling the wind deflector.

FIGS. 8A, 8B, 9A and 9B are lateral views and views from above, illustrating two of several different possibilities of supporting the wind deflector on a ground, and

FIGS. 10 and 11 show, in a view corresponding to FIG. 1 and in a view from above, respectively, a second preferred embodiment of the wind deflector.

### DETAILED DESCRIPTION OF PREFERRED EMBODIMENTS

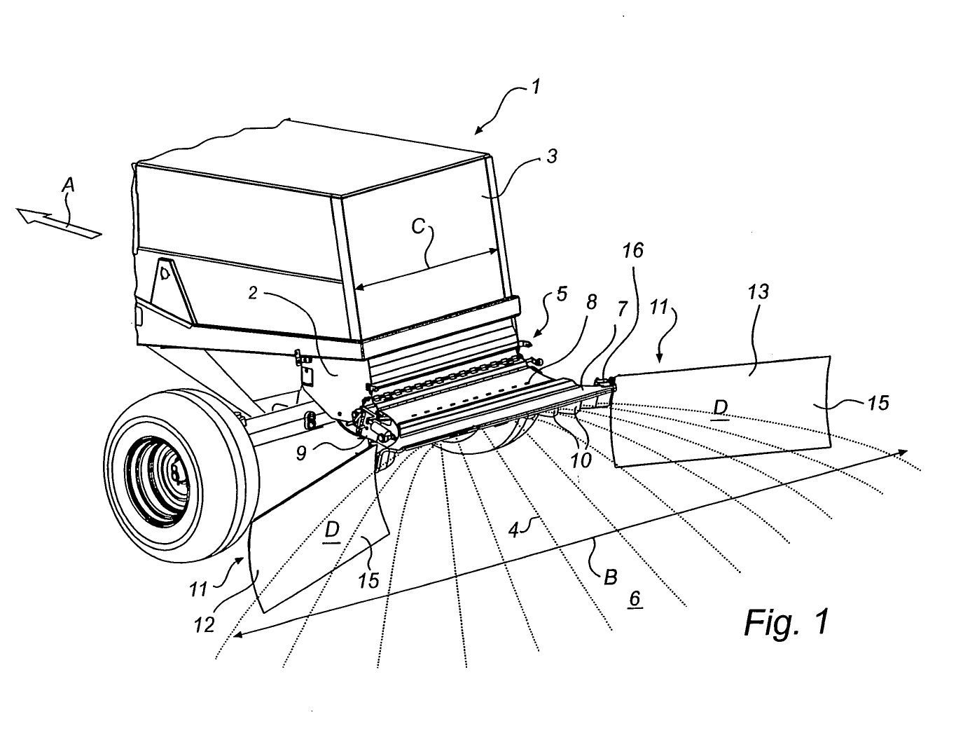

The combine harvester designated generally by numeral 1 and only partly shown in FIG. 1 is of rather conventional design and for this reason neither the function nor the construction of the combine harvester will be described in any detail herein.

The combine harvester 1 is, among other things, provided with a cutter 2 in the form of a straw chopper, preferably a flail chopper, of prior-art design. In the conventional manner the cutter 2 is placed at the rear end of the combine harvester 1 as seen in the direction of travel A of the latter. The cutter 2 is formed with an inlet, not shown, for reception of threshed but not yet chopped crop residues, usually straw emanating from such crops as wheat, barley, rye and oats a well as from oil-producing plants and maize, sunflower, etc, and with an outlet, not shown either, for chopped and comminuted crop residues 4.

The main task of a spreader 5 located at the rear or downstream from the cutter 2 is to spread the chopped crop residues 4, discharged from the cutter 2 through the outlet thereof, over a ground 6, in this case a field, across the desired spreading width B, the maximum width of which may amount to 9 meters or more, i.e. considerably wider than the width C of the combine harvester 1 itself and of the spreader 5, which usually amounts to 2.6 meters.

More precisely, the spreader 5 is configured essentially as a spreading nozzle 7, which is directed rearwards and is open in a downwards-rearwards direction. The nozzle 7 has an upper essentially horizontal wall 8 and two essentially vertical end walls 9. Below the upper wall 8 and intermediate the end walls 9 a plurality of spreader wings 10 are arranged, said wings being positioned essentially in juxtaposed parallel relationship and being pivotally mounted in the upper wall 8 for adjustment of the spreader wings 10 in the transverse direction of the spreader 5 as required by the desired spreading width and pattern.

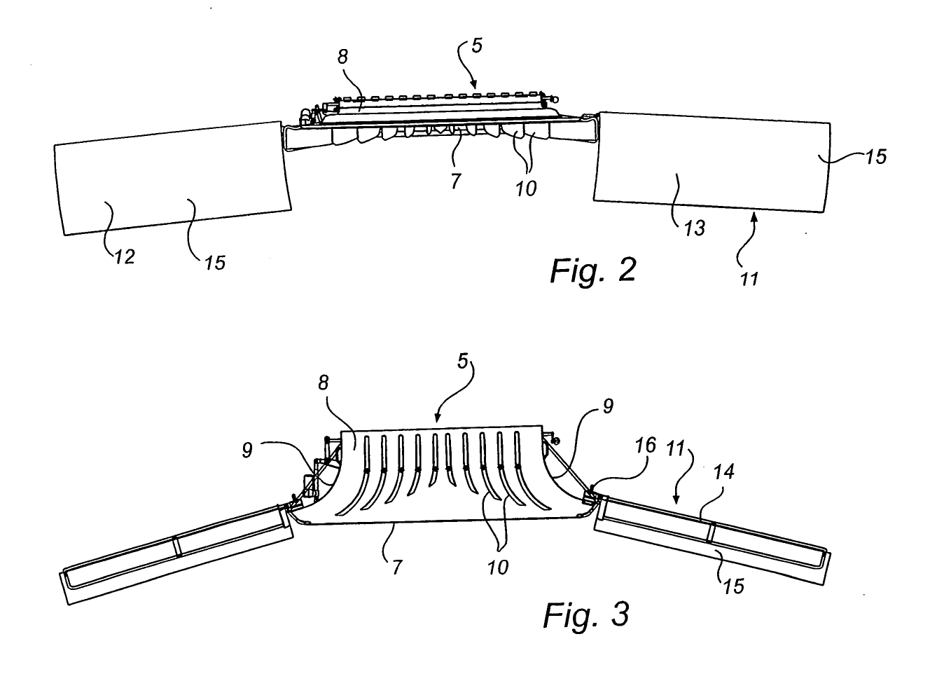

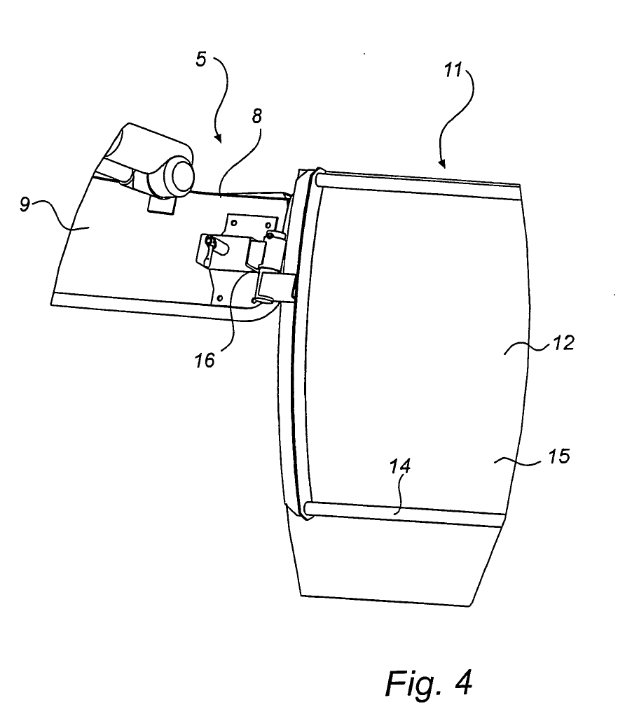

A wind deflector in accordance with the first preferred embodiment, designated generally in FIGS. 1-9 by numeral 11, is connected to the spreader 5. However, it could equally well be positioned on the rear end 3 of the combine harvester 1 or at some other suitable place. The essential is that the wind deflector be able to fulfil its main task, which is to prevent, during movement of the combine harvester 1 and consequently also that of the spreader 5 in the direction of travel A, headwinds or upwind acting essentially counter to the direction of travel A and/or the lateral winds acting more or less crosswise to the direction of travel A, from affecting the spreading of the crop residues 4 across the desired spreading width as determined by the setting of the spreader wings 10, particularly when they are set for maximum spreading width B.

More precisely, the wind deflector 11 projects essentially horizontally laterally, either obliquely or substantially at right angles to the direction of travel A, from at least one direction away from the spreader 5 (or the combine harvester 1).

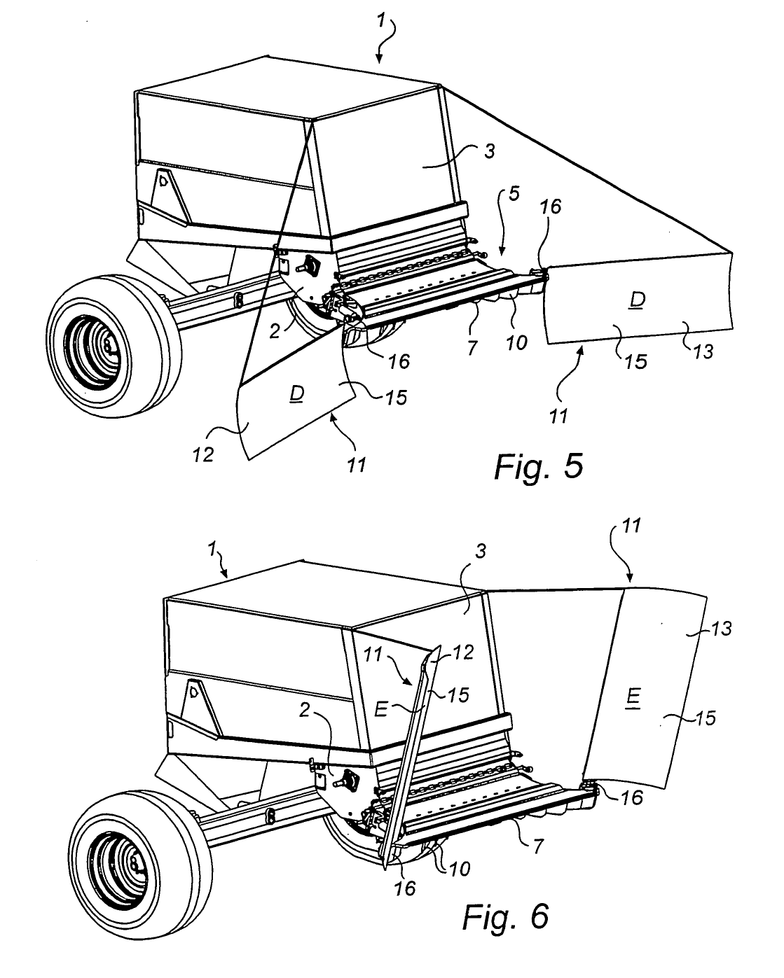

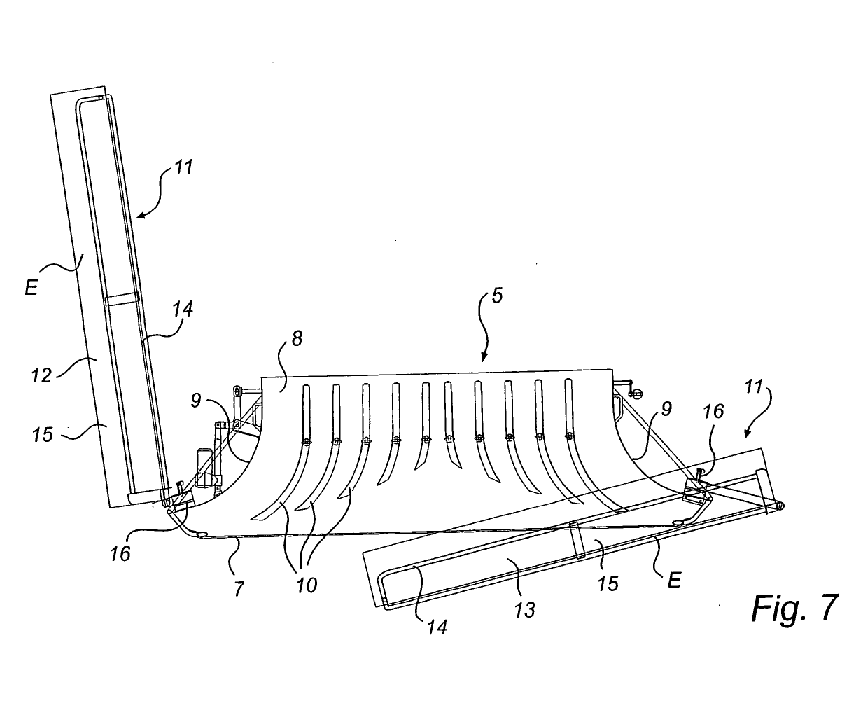

In the embodiment shown in FIGS. 1-9, the wind deflector 11 comprises two sections 12 and 13 arranged essentially in mirror-image relationship, said sections being connected to the spreader 5 on either side of the latter and projecting laterally as mentioned above in opposite directions from either side of the spreader. In this case, each section 12, 13 comprises a metal-tube frame 14 of a construction suitable for its purpose, and on the frame an essentially rectangular screen 15 made from sheet metal or some other suitable material is mounted by means of fasteners of a prior-art kind, not shown. By means of its tubular frame 14, each section 12, 13 is pivotally connected to the corresponding side of the spreader 5 by means of a pivot joint 16, which also allows the section to be mounted on/dismounted from the spreader in a quick and simple manner without any tools being required. Via the pivot joints 16 the sections 12, 13 may be controlled jointly (FIGS. 5 and 6) or individually (FIG. 7) between an operative position D (FIGS. 1-5, 8 and 9), wherein they project in the lateral direction essentially horizontally above the ground 6 and a position E of rest or transportation (FIGS. 6 and 7), wherein they do not project laterally.

According to FIGS. 5 and 6, the sections 12, 13 may be controlled by means of one single winch or by means of one winch each, not shown, or similar means arranged on the rear end 3 of the combine harvester 1 in a manner ensuring that they may be folded essentially vertically between their essentially horizontal, lower operative position D as shown in FIG. 5 and the essentially vertically upright position E of rest and transportation as shown in FIG. 6.

Alternatively, the sections 12, 13 may be controlled as shown in FIG. 7 by arranging them in such a manner that they may pivot essentially horizontally about the pivot points 16 between the operative position D and the position E of rest and transportation. In the position E of rest and transportation shown on the left-hand side of FIG. 7, the section is shown extending essentially in parallel with the direction of travel A, adjacent one of the lengthwise sides of the combine harvester, not shown in the drawing figure, whereas in the position of rest and transportation shown on the right-hand side of FIG. 7 the section is shown as folded inwards behind the spreader 5 and extending essentially at right angles to the direction of travel A.

Further additional positions E of rest and transportation of the sections 12, 13, even of dismounted sections as mentioned previously, are of course possible.

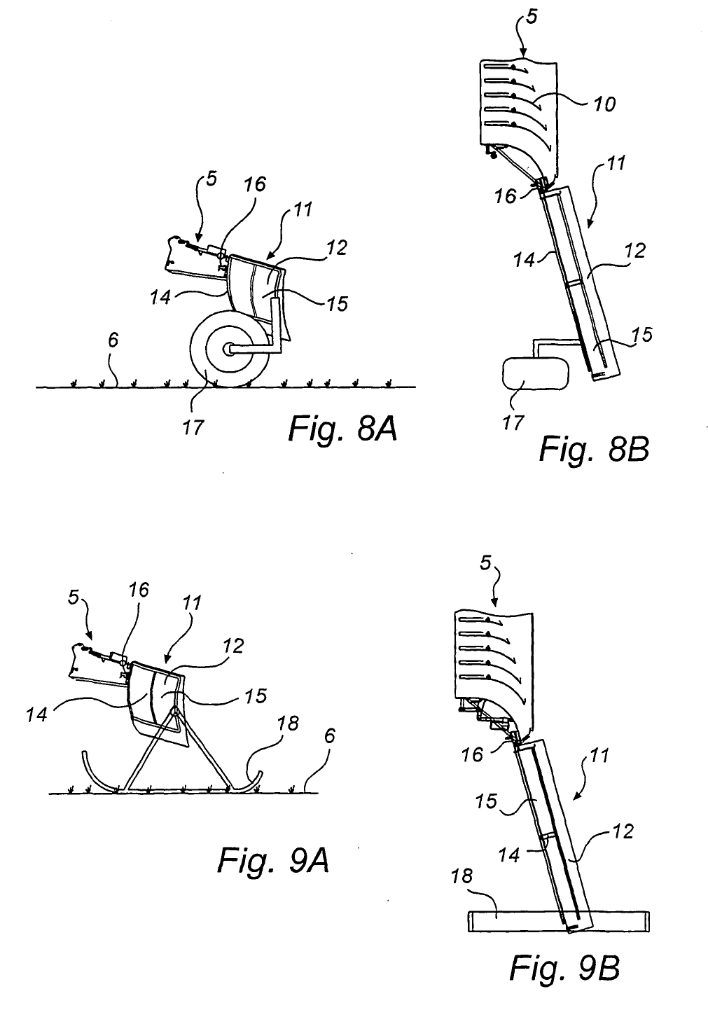

In some cases, for example when the sections 12, 13 are very long (up to 2-3 meters) and comparatively heavy, it may be advisable to support the sections in their operative position D as shown in FIGS. 8 and 9 by provision at their outer free ends or at a point spaced from these ends, of support wheels 17 (FIG. 8), preferably swivels or slide runners 18 (FIG. 9). Obviously, differently designed supports are possible; the essential is that the sections are not in direct contact with or strike the ground 6.

If the sections 12, 13, whether or not supported by means 17, 18 as defined above, should strike an obstacle, such as a stone, some other implement or any other hard object, preferably the joints 16 may be equipped with break-pins, not shown, yielding springs or the like. In this manner the section that strikes an obstacle may yield and be deflected to prevent it from being damaged by the obstacle or from causing damage to the latter.

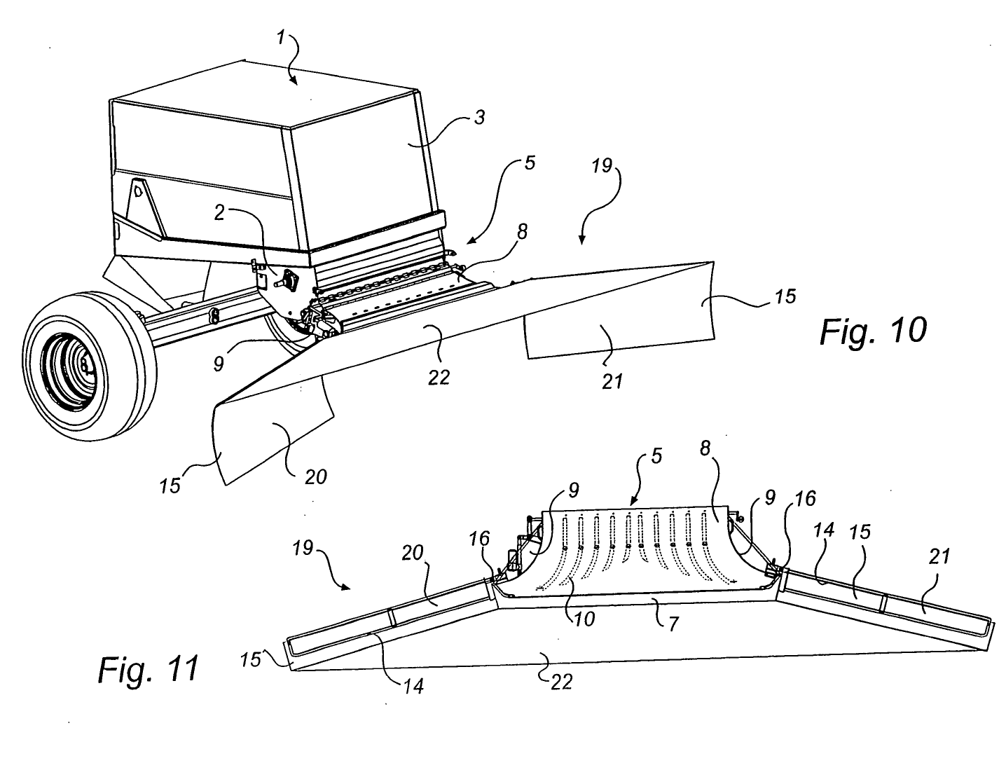

In the second preferred embodiments of the wind deflector 19 as shown in FIGS. 10 and 11, this deflector like the wind deflector 11 according to the first embodiment shown in FIGS. 1-9 is connected to the spreader 5 but alternatively it could be connected to the rear end 3 of the combine harvester or elsewhere. The wind deflector 19 operates principally in the same manner as the wind deflector 11 but differs somewhat construction-wise from the latter.

The wind deflector 19 comprises three sections 20, 21, and 22, of which sections 20, 21 on the whole are identical to sections 12, 13 of wind deflector 11. Section 22, which may be made from sheet metal or some other rigid material, interconnects sections 20, 21 and in the operative position D it extends essentially horizontally intermediate sections 20, 21, forming a roof. In this manner the wind deflector 19 assumes the shape of a funnel-like, hood-shaped extension of the spreader 5.

The control of the wind deflector 19 may be effected by pivoting it like a unit about a horizontal axis, which extends crosswise relative to the direction of travel A, between the downwards folded operative position D shown in FIGS. 10 and 11 and the upper position, not shown, of rest and transportation E. In practical terms, the control may be effected with the aid of such means as winches or equivalent means, not shown, arranged at the rear end 3 of the combine harvester 1.

According to the two embodiments shown herein and any other possible embodiments of the wind deflector 11, 19 it is possible to effect the control, in addition to manually by means of winches and the like, by hydraulically, pneumatically or electrically operated means or in some other way. Preferably, control of this kind is effected via lines and cables in order to facilitate operations by the driver from the driver's cabin of the combine harvester or, if the spreader 5 is not connected to a combine harvester but is a separated, driven or self-propelled unit, from the driver's cabin of the propelling vehicle or of the spreader.

As will be realised the invention should not be regarded as limited to the embodiments described herein and shown in the drawings but it may be varied optionally within the scope of protection as defined in the appended claims.

1. A spreader arranged to move one a ground for spreading crop residues over the ground behind the spreader, across the width that considerably exceeds the width of the spreader, the spreader comprising:
a wind deflector upon movement of the spreader prevents headwinds and/or lateral winds from affecting the spreading of the crop residues across the spreading width.

2. A spreader as claimed in claim 1, connected to the rear end of a combine harvester for spreading the crop residues exiting from a cutter incorporated in the combine harvester, wherein said spreader includes several spreader wings pivotally mounted on said spreader to define the desired spreading width and wherein said wind deflector is connected to said spreader or to the rear end of the combine harvester.

3. A spreader as claimed in claim 1, wherein said wind deflector projects essentially horizontally laterally, at least in one direction away from the spreader or the combine harvester.

4. A spreader as claimed in claim 1, wherein said wind deflector includes at least two sections, connected to the spreader or the combine harvester on both sides thereof and which project laterally therefrom in opposite directions.

5. A spreader as claimed in claim 4, wherein said sections are pivotally connected to the associated side of the spreader or the combine harvester and is controlled jointly or individually between an operative position, wherein they project laterally, and a position of rest and transportation, wherein they do not project laterally.

6. A spreader as claimed in claim 5, wherein said sections are controllable either to be folded essentially vertically between an essentially horizontal, lower operative position and an essentially vertical upper position of rest and transportation, or are controllable for pivotal movement essentially horizontally between an essentially horizontal operative position and an equally essentially horizontal position of rest and transportation.

7. A spreader as claimed in claim 5, wherein in their operative position said sections are supported on the ground by supports such as wheels, runners and the like positioned at the outer free section ends.

8. A spreader as claimed in claim 4, wherein the sections are designed as essentially rectangular screens, which extend essentially vertically in the operative position and which project obliquely outwards and rearwards laterally from the spreader or the combine harvester.

9. A spreader as claimed in claim 8, wherein the sections are interconnected by way of a section, the operative position forms an upper, essentially horizontally extending section so as to form a funnel-like, hood-shaped extension of the spreader.

10. A spreader as claimed in claim 5, wherein control of the sections is effected at least one of manuals, pneumatically.

11. A spreader as claimed in claim 2, wherein said wind deflector projects essentially horizontally laterally, at least in one direction away from the spreader or the combine harvester.

12. A spreader as claimed in claim 2, wherein said wind deflector includes at least two sections, connected to the spreader or the combine harvester on both sides thereof and which project laterally therefrom in opposite directions.

13. A spreader as claimed in claim 3, wherein said wind deflector includes at least two sections, connected to the spreader or the combine harvester on both sides thereof and which project laterally therefrom in opposite directions.

14. A spreader as claimed in claim 6, wherein in their operative position said sections are supported on the ground by supports such as wheels, runners and the like positioned at the outer free section ends.

15. A spreader as claimed in claim 5, wherein the sections are designed as essentially rectangular screens, which extend essentially vertically in the operative position and which project obliquely outwards and rearwards laterally from the spreader or the combine harvester.

16. A spreader as claimed in claim 6, wherein the sections are designed as essentially rectangular screens, which extend essentially vertically in the operative position and which project obliquely outwards and rearwards laterally from the spreader or the combine harvester.

17. A spreader as claimed in claim 7, wherein the sections are designed as essentially rectangular screens, which extend essentially vertically in the operative position and which project obliquely outwards and rearwards laterally from the spreader or the combine harvester.

18. A spreader as claimed in claim 6, wherein control of the sections is effected at least one of manuals, pneumatically.
